(19) United States
(12) Patent Application Publication
(10) Pub. No.: US 2017/0263937 A1
(43) Pub. Date: Sep. 14, 2017

(54) COMPOSITE BINDER, CATHODE ELECTRODE OF LITHIUM RECHARGEABLE BATTERY USING THE SAME AND METHOD FOR MAKING THE SAME

(71) Applicants: JIANGSU UNIONENERGY LITHIUM SULFUR BATTERY TECHNOLOGY CO., LTD., Suzhou (CN); JIANGSU HUADONG INSTITUTE OF LI-ION BATTERY CO., LTD., Suzhou (CN); TSINGHUA UNIVERSITY, Beijing (CN)

(72) Inventors: Peng Zhao, Beijing (CN); Li Wang, Beijing (CN); Xiang-Ming He, Beijing (CN); Jian-Jun Li, Beijing (CN); Yu-Ming Shang, Beijing (CN); Ju-Ping Yang, Beijing (CN); Jiang Cao, Beijing (CN); Yu-Feng Zhang, Beijing (CN); Jian Gao, Beijing (CN); Yao-Wu Wang, Beijing (CN)

(73) Assignees: JIANGSU UNIONENERGY LITHIUM SULFUR BATTERY TECHNOLOGY CO., LTD., Suzhou (CN); JIANGSU HUADONG INSTITUTE OF LI-ION BATTERY CO., LTD., Suzhou (CN); TSINGHUA INVERSITY, Beijing (CN)

(21) Appl. No.: 15/603,949

(22) Filed: May 24, 2017

Related U.S. Application Data
(63) Continuation of application No. PCT/CN2015/093465, filed on Oct. 30, 2015.

(30) Foreign Application Priority Data
Nov. 25, 2014 (CN) 201410685339.X

(51) Int. Cl. H01M 4/62; H01M 4/38; H01M 10/0525; C08L 27/16

(52) U.S. Cl. CPC H01M 4/623; C08L 27/16; H01M 4/38; H01M 4/625; H01M 10/0525; C08L 2203/20; H01M 2004/028

(57) ABSTRACT

A composite binder includes an organic-inorganic hybrid polymer and a fluorinated binder uniformly mixed with each other. A repeating unit of the organic-inorganic hybrid polymer includes a silicon atom, a methacryloyloxy group, or an acryloyloxy group, and at least two alkoxy groups. The alkoxy groups and the methacryloyloxy group or the acryloyloxy group are respectively joined to the silicon atom. A method for making a cathode electrode and the cathode electrode are also disclosed.

### CROSS-REFERENCE TO RELATED APPLICATIONS

This application claims all benefits accruing under 35 U.S.C. §119 from China Patent Application No. 201410685339.X, filed on Nov. 25, 2014 in the State Intellectual Property Office of China, the content of which is hereby incorporated by reference. This application is a continuation under 35 U.S.C. §120 of international patent application PCT/CN2015/093465 filed on Oct. 30, 2015, the content of which is also hereby incorporated by reference.

### FIELD

The present disclosure relates to batteries, and more particularly relates to composite binders, and applications of the composite binders in lithium rechargeable batteries.

### BACKGROUND

A sulfur cathode electrode in a lithium rechargeable battery is prone to have volume expansion/contraction in cycling the battery, which can decrease battery capacity.

Binder is an inactive component in an electrode of the lithium rechargeable battery. A main function of the binder is to bond the electrode active material and enhance an electrical contact between the electrode active material, the conducting agent, and the current collector to maintain the structure of the electrode. In addition, the binder can provide sufficient mechanical performance and processibility to the electrode to meet actual needs for fabrication. Since the volumes of the cathode electrode and anode electrode of the lithium rechargeable battery have changes during the charging and discharging of the battery, the binder should act as a volume buffer so that the coating film containing the active material will not detach from the current collector and form a crack. Though an amount used in the electrode is small, the binder has a great influence on the fabrication and performance of the lithium rechargeable battery, so it is an important auxiliary material in battery industry.

A commonly used binder in lithium rechargeable batteries is polyvinylidene fluoride (PVDF). PVDF can produce a reversible deformation usually only within a volume change of about 10%. However, many cathode materials have larger volume changes. In an example, the volume change of a sulfur cathode material can reach 24% in a charge and discharge process of the battery. In this battery, the volume expansion/contraction of the electrode active material in the electrochemical cycling leads to the separation of the electrode active material from the conducting agent and the binder, which are originally in contact with each other. The electrode active material is detached, and cracks are formed on the surface of the electrode and between the material and the current collector, so that the problem of the capacity decay is not effectively solved.

### SUMMARY

One aspect of the present disclosure is to provide a composite binder, a cathode electrode of a lithium rechargeable battery using the same, and a method for making the cathode electrode to suppress the volume change of the sulfur cathode active material thereby improving the cycling performance of the battery.

The composite binder comprises an organic-inorganic hybrid polymer and a fluorinated binder uniformly mixed with each other. Each repeating unit of the organic-inorganic hybrid polymer comprises a silicon atom, a methacryloyloxy group or an acryloyloxy group, and at least two alkoxy groups. The alkoxy groups and the methacryloyloxy group or the acryloyloxy group are respectively joined to the silicon atom.

The method for making the cathode electrode comprises:

providing the composite binder and sulfur grains as a cathode active material;

uniformly mixing the composite binder and the sulfur grains to form a slurry; and

coating the slurry on a surface of a current collector to form a cathode electrode plate; and

disposing the cathode electrode plate in an acidic environment or an alkaline environment to induce a condensation reaction of the organic-inorganic hybrid polymer in the composite binder.

The cathode electrode of the lithium rechargeable battery comprises the current collector and an electrode material layer disposed on the surface of the current collector. The electrode material layer comprises a condensation product of the organic-inorganic hybrid polymer, the sulfur grains, and the fluorinated binder.

Alternatively, the cathode electrode of the lithium rechargeable battery comprises the current collector and an electrode material layer disposed on the surface of the current collector. The electrode material layer comprises the sulfur grains, the fluorinated binder, and a silicon-oxygen crosslinked network disposed on a surface of the sulfur grains. The silicon-oxygen crosslinked network comprises:

a chemical group

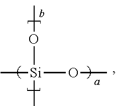

wherein a and b are both in a range of 1 to 10000 and independent of each other.

### BRIEF DESCRIPTION OF THE DRAWINGS

Implementations are described by way of example only with reference to the attached figures.

FIG. 1 shows X-ray photoelectron spectroscopy (XPS) curves of one embodiment of the organic-inorganic hybrid polymer before and after a condensation reaction.

FIG. 2 shows electrochemical cycling curves of lithium rechargeable batteries in Example 1 and Comparative Example.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

One embodiment of a composite binder comprises an organic-inorganic hybrid polymer and a fluorinated binder uniformly mixed with each other. Each repeating unit of the organic-inorganic hybrid polymer comprises a silicon atom, a methacryloyloxy group or an acryloyloxy group, and at least two alkoxy groups. The alkoxy groups and the methacryloyloxy group or the acryloyloxy group are respectively joined to the silicon atom.

An amount of the repeating units in the organic-inorganic hybrid polymer can be about 40 to about 5000. The organic-inorganic hybrid polymer can be at least one of poly-γ-(triethoxysilyl)propyl methacrylate, poly-γ-(trimethoxysilyl)propyl methacrylate, poly-γ-methacryloxypropylmethyldimethoxysilane, poly-(diethoxymethylsilyl)propyl methacrylate, poly-γ-acryloxypropyltriethoxysilane, poly-γ-acryloxypropyltrimethoxysilane, poly-γ-acryloxypropylmethyldimethoxysilane, poly-acryloxypropylmethyldiethoxysilane, and poly-acryloxypropylmethyldimethoxysilane.

The organic-inorganic hybrid polymer can be prepared by the steps of:

S11, providing a silicon-oxygen organic monomer comprising a silicon atom, a methacryloyloxy group or an acryloyloxy group, and at least two alkoxy groups. The alkoxy groups and the methacryloyloxy group or the acryloyloxy group are respectively joined to the silicon atom.

S12, polymerizing the silicon-oxygen organic monomer.

In S11, the silicon-oxygen organic monomer comprises the methacryloyloxy group (H₂C═C(CH₃)COO—) or the acryloyloxy group (H₂C═CHCOO—). The silicon-oxygen organic monomer also comprises the alkoxy groups (—ORO₁). The methacryloyloxy group or the acryloyloxy group and the alkoxy groups are respectively connected to the silicon atom to form a silicon-oxygen (Si—O) group in the silicon-oxygen organic monomer. The alkoxy groups can be the same or different from each other. In one embodiment, the silicon-oxygen organic monomer comprises —Si(OR₁)ₓ(R₂)_{y}, wherein x+y=3, x≧2, y≧0. In one embodiment, x is 3, and y is 0. R₂ can be a hydrocarbon group or hydrogen. In one embodiment, R₂ is an alkyl group, such as —CH₃ or —C₂H₅. R₁ can be an alkyl group, such as —CH₃ or —C₂H₅. The methacryloyloxy group or the acryloyloxy group can be joined to the —Si(OR₁)ₓ(R₂)_{y} through an organic group, such as alkanes, alkenes, alkynes, cycloalkanes, or aromatic groups.

The silicon-oxygen organic monomer can be represented by a formula:

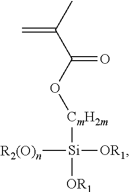

wherein n is 0 or 1, and m is 1 to 5, such as 3.

The silicon-oxygen organic monomer can be at least one of γ-(triethoxysilyl)propyl methacrylate, γ-(trimethoxysilyl)propyl methacrylate, γ-methacryloxypropylmethyldimethoxysilane, (diethoxymethylsilyl)propyl methacrylate, γ-acryloxypropyltriethoxysilane, γ-acryloxypropyltrimethoxysilane, γ-acryloxypropylmethyldimethoxysilane, acryloxypropylmethyldiethoxysilane, and acryloxypropylmethyldimethoxysilane.

In S12, the polymerizing comprises:

S121, uniformly mixing a free radical initiator and the silicon-oxygen organic monomer to form a homogeneous solution;

S122, stirring the homogeneous solution at a heating condition to polymerize the silicon-oxygen organic monomer to form the organic-inorganic hybrid polymer.

In S121, the initiator is capable of initiating the polymerization between the silicon-oxygen organic monomer. The initiator can be azobisisobutyronitrile (AIBN) azobisdimethylvaleronitrile (AIVN) or benzoyl peroxide (BPO). In S122, the heating temperature can be 60° C. to 90° C. The method can further comprise a step of purifying the organic-inorganic hybrid polymer after the polymerization is completed. The purification can be a dissolution-precipitation-washing method, and in one embodiment, the method comprises:

S123, adding a first solvent to the product obtained from the polymerization to form a mixed solution, wherein the first solvent is miscible with the organic-inorganic hybrid polymer;

S124, gradually adding the mixed solution to a second solvent to precipitate the organic-inorganic hybrid polymer; and

S125, separating the organic-inorganic hybrid polymer from the solvents.

In S123, the concentration of the mixed solution is adjusted so that the mixed solution becomes a flowable homogeneous liquid. In S124, the mixed solution can be added drop by drop to the second solvent to have the organic-inorganic hybrid polymer precipitated in the solvents. Then the organic-inorganic hybrid polymer can be washed.

The sequence from S123 to S124 can be repeated a plurality of times to obtain a pure organic-inorganic hybrid polymer.

The first solvent is miscible with the organic-inorganic hybrid polymer. The first solvent can be tetrahydrofuran or acetone. The organic-inorganic hybrid polymer has a low solubility in the second solvent, such that the organic-inorganic hybrid polymer can be precipitated. The second solvent can be at least one of water, ethanol, and methanol. In one embodiment, the second solvent is a mixed solvent of water and methanol.

In S125, the separating can be carried out by filtrating and drying.

The fluorinated binder can be a binder commonly used in the electrodes of the lithium rechargeable batteries. The fluorinated binder meets at least the following requirements: (1) the fluorinated binder is capable of binding the electrode active material and binding the electrode active material to the current collector; (2) the fluorinated binder is has stable structure and property in the electrolyte; and (3) the fluorinated binder is electrochemical stable during the electrochemical cycle. In one embodiment, the fluorinated binder can further act as a volume buffer so that the electrode active material is less likely to be detached from the current collector or form a crack.

The fluorinated binder can be at least one of polyvinylidene fluoride (PVDF), hexafluoropropylene (HFP), tetrafluoroethylene (TFE), and trichlorofluoroethylene (CTFE). In one embodiment, the fluorinated binder can be at least one of copolymers of HFP, TFE, CTFE, and PVDF.

A mass ratio of the fluorinated binder to the organic-inorganic hybrid polymer is 1:20 to 10:1. In some embodiments, the mass ratio of the fluorinated binder to the organic-inorganic hybrid polymer is 1:5 to 10:1. The fluorinated binder can resist deformation in these ranges. In one embodiment, the mass ratio of the fluorinated binder to the organic-inorganic hybrid polymer is 2:1.

The composite binder can further comprise a third solvent. The organic-inorganic hybrid polymer and the fluorinated binder are soluble in the third solvent to form a binder solution. The binder solution is easy to coat evenly. The third solvent can be an organic solvent. The organic solvent can be at least one of N-methylpyrrolidone, tetrahydrofuran, and acetone.

The composite binder can be used to bind the cathode active material to the cathode current collector in the cathode electrode of the lithium rechargeable battery.

One embodiment of a method for preparing the cathode electrode of the lithium rechargeable battery comprises:

B 1, providing the composite binder and the sulfur grains, the sulfur grains are used as the cathode active material;

B2, uniformly mixing the composite binder and the sulfur grains to form a slurry;

B3, coating the slurry on a surface of the cathode current collector to form a cathode electrode plate; and

B4, disposing the cathode electrode plate in an acidic environment or an alkaline environment to induce a condensation reaction of the organic-inorganic hybrid polymer in the composite binder.

A mass percentage of the composite binder in the slurry can be in a range from about 5% to about 20%. In one embodiment, the composite binder in the slurry can be in a range from about 5% to about 8%. The composite binder can improve a discharge specific capacity of sulfur.

One embodiment of B2 is uniformly mixing the composite binder, the conducting agent, and the sulfur grains to form the slurry. The conducting agent improves the electrical conductivity of the sulfur grains and the cathode electrode. The conducting agent can be a conducting carbon material, such as at least one of conducting graphite, acetylene black, carbon black, carbon nanotubes, and graphene.

The composite binder can further comprise the third solvent to uniformly mix the composite binder with the sulfur grains and to form a uniform coating layer on the current collector.

The current collector is a conducting material that is configured to carry the electrode active material. A material of the current collector can be metal or conducting carbon materials.

After B3, the method can further comprise a step of drying the cathode electrode plate to remove the solvent in the coating layer, and to tightly bind the sulfur grains on the current collector after the condensation reaction.

In B4, the acidic environment can be an acidic gas or an acidic liquid; the alkaline environment can be an alkaline gas or an alkaline liquid. In one embodiment, the material of the current collector is metal, and the electrode plate is disposed in the alkaline environment. The alkaline environment can be ammonia gas, ammonia water, or sodium carbonate solution. In the acidic or alkaline environment, a condensation reaction occurs between the alkoxy groups attached to the silicon atom in the organic-inorganic hybrid polymer. The condensation reaction can be represented by a equation:

—SiOR₁+—SiOR₁→—Si—O—Si—

The condensation reaction forms a silicon-oxygen link comprising of alternatively joined silicon atoms and oxygen atoms. As the organic-inorganic hybrid polymer comprises at least two Si—O bonds, the condensation reaction can form a silicon-oxygen crosslinked network, in which at least two silicon-oxygen chains cross with each other and at least one silicon atom is shared at the crossing point to form the chemical group

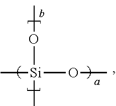

wherein a and b are both in a range of 1 to 10000 and independent of each other.

The silicon-oxygen crosslinked network coats the surfaces of the sulfur grains and firmly binds the sulfur grains to the current collector, greatly increasing a binding force between the sulfur grains and the current collector.

One embodiment of the cathode electrode of the lithium rechargeable battery comprises the current collector and a cathode material layer disposed on the surface of the current collector. The electrode material layer comprises uniformly distributed condensation product of the organic-inorganic hybrid polymer, the sulfur grains, and the fluorinated binder.

One embodiment of a lithium rechargeable battery comprises the cathode electrode, an anode electrode, a separator, and a nonaqueous electrolyte solution, wherein the separator is disposed between the cathode electrode and the anode electrode.

### EXAMPLE 1

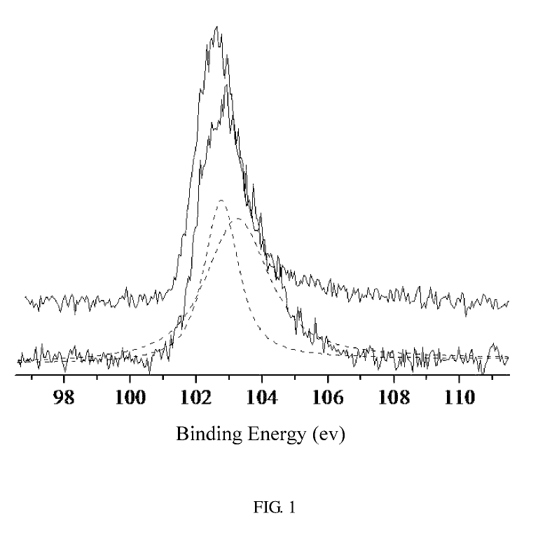

The azobisisobutyronitrile (AIBN) is dissolved in γ-(triethoxysilyl)propyl methacrylate and stirred at 80° C. to have a polymerization reaction. The product of the polymerization reaction is diluted with tetrahydrofuran and precipitated in a mixed solvent of methanol and water for three times to extract the organic-inorganic hybrid polymer (poly-γ-(triethoxysilyl)propyl methacrylate, PTEPM). The PTEPM and PVDF are dissolved in NMP. The slurry is formed, in which a mass ratio of sulfur:conducting graphite:acetylene black:PVDF:PTEPM=4.5:2:2:1:0.5. The slurry is coated on the surface of the current collector to form the cathode electrode plate. The cathode electrode plate is disposed in the atmosphere containing the ammonia gas to have the condensation reaction of silicon-oxygen bonds in the organic-inorganic hybrid polymer in the composite binder, thereby forming the sulfur cathode electrode. Referring to FIG. 1, it can be seen that two peaks (dash lines, one is at 102.1 ev, the other is at 103.7 ev) can be fitted based on the XPS curves before and after the condensation reaction. The former peak represents the absorption of silicon-oxygen-carbon (PTEPM) (the characteristic absorption is referred to S-C-PVDF-PTEPM), and the latter peak represents the absorption of silicon-oxygen-silicon (the characteristic absorption is referred to S-C-PVDF-SiO₂), showing that the condensation reaction occurs.

### COMPARATIVE EXAMPLE

The Comparative Example is substantially the same as the Example 1, except that the binder used in forming the sulfur cathode electrode is only PVDF, without PTEPM.

The sulfur cathode electrodes formed in Example 1 and Comparative Example are separately assembled into lithium rechargeable batteries (except the cathode electrodes, the other conditions are the same). The two batteries are electrochemical cycled in the same conditions.

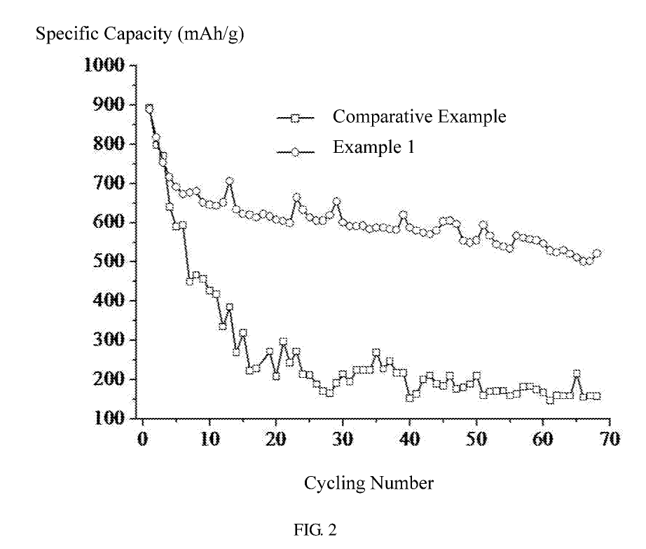

Referring to FIG. 2, the electrochemical cycle performance and the capacity retention of the lithium rechargeable battery using the cathode electrode of Example 1 is remarkably improved with respect to the lithium rechargeable battery using the cathode electrode of Comparative Example.

The composite binder is formed by mixing the organic-inorganic hybrid polymer with the fluorinated binder, each repeating unit of the organic-inorganic hybrid polymer comprises a silicon atom, a methacryloyloxy group or an acryloyloxy group, and at least two alkoxy groups. The composite binder is used in the cathode electrode of the lithium rechargeable battery using sulfur as the cathode active material, and can effectively buffer the volume change of the sulfur during the electrochemical cycle, and can effectively improve the electrochemical performance and the capacity retention of the battery.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A composite binder comprising:
an organic-inorganic hybrid polymer, a repeating unit of the organic-inorganic hybrid polymer comprising a silicon atom, a methacryloyloxy group or an acryloyloxy group, and at least two alkoxy groups, the at least two alkoxy groups and the methacryloyloxy group or the acryloyloxy group are respectively joined to the silicon atom; and
a fluorinated binder uniformly mixed with each other.

2. The composite binder of claim 1, wherein a number of the repeating units in the organic-inorganic hybrid polymer is in a range from about 40 to about 5000.

3. The composite binder of claim 1, wherein the organic-inorganic hybrid polymer is selected from the group consisting of poly-γ-(triethoxysilyl)propyl methacrylate, poly-γ-(trimethoxysilyl)propyl methacrylate, poly-γ-methacryloxypropylmethyldimethoxysilane, poly-(diethoxymethylsilyl)propyl methacrylate, poly-γ-acryloxypropyltriethoxysilane, poly-γ-acryloxypropyltrimethoxysilane, poly-γ-acryloxypropylmethyldimethoxysilane, poly-acryloxypropylmethyldiethoxysilane, poly-acryloxypropylmethyldimethoxysilane, and combinations thereof.

4. The composite binder of claim 1, wherein the fluorinated binder is selected from the group consisting of polyvinylidene fluoride, hexafluoropropylene, tetrafluoroethylene, trichlorofluoroethylene, and combinations thereof.

5. The composite binder of claim 1, wherein a mass ratio of the fluorinated binder to the organic-inorganic hybrid polymer is 1:20 to 10:1.

6. The composite binder of claim 1, wherein a mass ratio of the fluorinated binder to the organic-inorganic hybrid polymer is 1:5 to 10:1.

7. The composite binder of claim 1 further comprising a third solvent, wherein the organic-inorganic hybrid polymer and the fluorinated binder are soluble in the third solvent to form a binder solution.

8. A method for preparing a cathode electrode, the method comprising:
providing a composite binder and sulfur grains, the composite binder comprising:
an organic-inorganic hybrid polymer, a repeating unit of the organic-inorganic hybrid polymer comprising a silicon atom, a methacryloyloxy group, or an acryloyloxy group, and at least two alkoxy groups, the at least two alkoxy groups and the methacryloyloxy group or the acryloyloxy group are respectively joined to the silicon atom; and
a fluorinated binder uniformly mixed with each other;
uniformly mixing the composite binder and the sulfur grains to form a slurry;
coating the slurry on a surface of a current collector to form a cathode electrode plate; and
disposing the cathode electrode plate in an acidic environment or an alkaline environment to induce a condensation reaction of the organic-inorganic hybrid polymer in the composite binder.

9. The method of claim 8, wherein a mass percentage of the composite binder in the slurry is in a range from about 5% to about 20%.

10. The method of claim 8, wherein the uniformly mixing the composite binder and the sulfur grains is uniformly mixing the composite binder, a conducting agent, and the sulfur grains to form the slurry.

11. The method of claim 8, wherein the acidic environment is an acidic gas or an acidic liquid; the alkaline environment is an alkaline gas or an alkaline liquid.

12. The method of claim 8, wherein the alkaline environment is ammonia gas, ammonia water, or sodium carbonate solution.

13. The method of claim 8, wherein the condensation reaction forms a silicon-oxygen link consisted of alternatively joined silicon atoms and oxygen atoms.

14. The method of claim 8, wherein the condensation reaction forms a silicon-oxygen crosslinked network comprising a chemical group 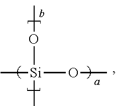
wherein a and b are both in a range of 1 to 10000 and independent of each other.

15. A cathode electrode, comprising:
a current collector; and
an electrode material layer disposed on the surface of the current collector, the electrode material layer comprising a condensation product of an organic-inorganic hybrid polymer, the sulfur grains, and the fluorinated binder,
wherein a repeating unit of the organic-inorganic hybrid polymer comprises a silicon atom, a methacryloyloxy group, or an acryloyloxy group, and at least two alkoxy groups, the alkoxy groups and the methacryloyloxy group or the acryloyloxy group are respectively joined to the silicon atom.

16. The cathode electrode of claim 15, wherein the condensation product comprises a silicon-oxygen link comprising alternatively joined silicon atoms and oxygen atoms.

17. The cathode electrode of claim 15, wherein the condensation reaction comprises a silicon-oxygen crosslinked network comprising a chemical group 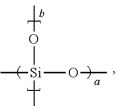
wherein a and b are both in a range of 1 to 10000 and independent of each other.
